(19) United States
(12) Patent Application Publication
(10) Pub. No.: US 2026/0347151 A1
(43) Pub. Date: Nov. 5, 2026

(54) CONTAINER HANDLING SYSTEM AND METHOD

(71) Applicant: RAM LIFTING TECHNOLOGIES PTE. LTD., Singapore (SG)

(72) Inventors: Ghee Hua NG, Singapore (SG); Zhan Min TONG, Singapore (SG); Yong Heng TAN, Singapore (SG)

(21) Appl. No.: 19/102,824

(22) PCT Filed: Aug. 10, 2023
(86) PCT No.: PCT/SG2023/050548

§ 371 Date: Feb. 10, 2025

(30) Foreign Application Priority Data
Aug. 11, 2022 (SG) 10202250702X

(51) Int. Cl. B66C 1/10; B65G 63/04; B66C 1/66; B66F 9/18

(52) U.S. Cl. CPC B66C 1/102; B65G 63/045; B66C 1/663; B66F 9/186

(57) ABSTRACT

A spreader system comprising: a pair of couplable spreader; a first of the pair of spreaders having at least one projection, said projection arranged to selectively extend from a coupling end of the first spreader into an aperture at a coupling end of the second spreader, when said spreaders are proximate to each other; wherein, on receiving the at least one projection into said corresponding aperture, a load transfer couple is formed such that the two couplable spreaders are arranged to act as a single unitary spreader.

### CROSS-REFERENCE TO RELATED APPLICATIONS

This application is a National Stage Application of PCT/SG2023/050548, filed Aug. 10, 2023, which claims benefit of priority to Singapore Patent Application No. 10202250702X filed on Aug. 11, 2022, and which applications are incorporated herein by reference. To the extent appropriate, a claim of priority is made to each of the above disclosed applications.

### TECHNICAL FIELD

This patent document relates to the engagement and movement of containers, and in particular to improved spreaders for engaging a wider range of shipping containers.

### BACKGROUND

While the containerized system of shipping containers is well standardized, there is still a diversity of shipping containers that need to be managed in a container yard on a daily basis. The most common diversity is being able to manage both 40 foot and 20 foot containers with a rapid turnaround time using the same equipment given that changing equipment such as spreaders can lead to significant downtime during normal operation.

The ability to shift between 40 foot and 20 foot containers using a single type of spreader is therefore highly useful.

### SUMMARY

A first aspect, the invention provides a spreader system comprising: a pair of couplable spreader; a first of the pair of spreaders having at least one projection, said projection arranged to selectively extend from a coupling end of the first spreader into an aperture at a coupling end of the second spreader, when said spreaders are proximate to each other; wherein, on receiving the at least one projection into said corresponding aperture, a load transfer couple is formed such that the two couplable spreaders are arranged to act as a single unitary spreader.

In a second aspect, the invention provides method of coupling a pair of couplable spreaders, the method comprising the steps of: bringing coupling ends of said spreaders proximate to each other; selectively extending at least one projection from a first of said spreaders; inserting the at least projection into a corresponding aperture of a second of said spreaders; and consequently, forming a load transfer couple such that the two couplable spreaders are arranged to act as a single unitary spreader.

The invention therefore provides a load transfer couple to selectively extend from a first spreader to the next. On coupling, flexural and torsional loads are transferable between the spreader, and so allowing the two spreaders to act as a single unitary spreader.

In various embodiments, the coupling of the spreaders may occur when both spreaders are supported, such as on a container or purpose-built frame. Alternatively, the spreaders may be coupled in mid-air. In so doing, various clamping and alignment devices may be employed to facilitate the coupling process, in the absence of a supporting structure.

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIGS. 1A to 1G are sequential elevation views of two couplable spreaders according to one embodiment of the present invention;

FIGS. 2A to 2E are various views of a couplable spreader having a load transfer coupling assembly according to one embodiment of the present invention;

FIGS. 3A to 3D are various views of a guide clamp assembly according to a further embodiment of the present invention;

FIGS. 4A and 4B are sequential views of a twistlock retraction assembly according to one embodiment of the present invention;

FIGS. 5A and 5B are sequential views of a spreader coupling process according to a further embodiment of the present invention;

FIGS. 6A to 6H are various views of a load transfer coupling assembly according to a further embodiment of the present invention;

FIG. 7 is an isometric view of a couplable spreader according to a further embodiment of the present invention and;

FIG. 8 is a detail elevation view of a twistlock retraction system according to a further embodiment of the present invention.

### DETAILED DESCRIPTION OF THE INVENTION

The invention is generally directed to a spreader system having two couplable spreaders that are able to handle containers as two independent spreaders or selectively coupled together to form a single unitary spreader. The coupling occurs on a projection from a first of said spreaders extending and entering into a corresponding aperture of said other spreader, when said spreaders are proximate. On receiving the projection into the corresponding aperture, a load transfer couple is formed such that the two coupled spreaders are arranged to act as a single unitary spreader.

In one embodiment, two 20 ft couplable spreaders which may work independently on two independent cranes and each to pick up one 20 ft container. A gap may be maintained in the longitudinal direction between the two spreaders to allow the two spreaders/cranes to travel across each other in lateral direction without interference. Such a gap may not be required if the spreaders do not cross each other path.

Instead of having the two spreaders working on two independent cranes, it is also possible for the two spreaders to work independently on a single crane that have two independent hoist systems on a common trolleying system. It is even possible for the two spreaders to work on a common crane that have single hoisting and single trolleying system, in which only the spreader operation (such as picking up container with twistlock) is independent, the hoisting and trolleying will be common for both spreaders as they are on the same hoist & trolley system.

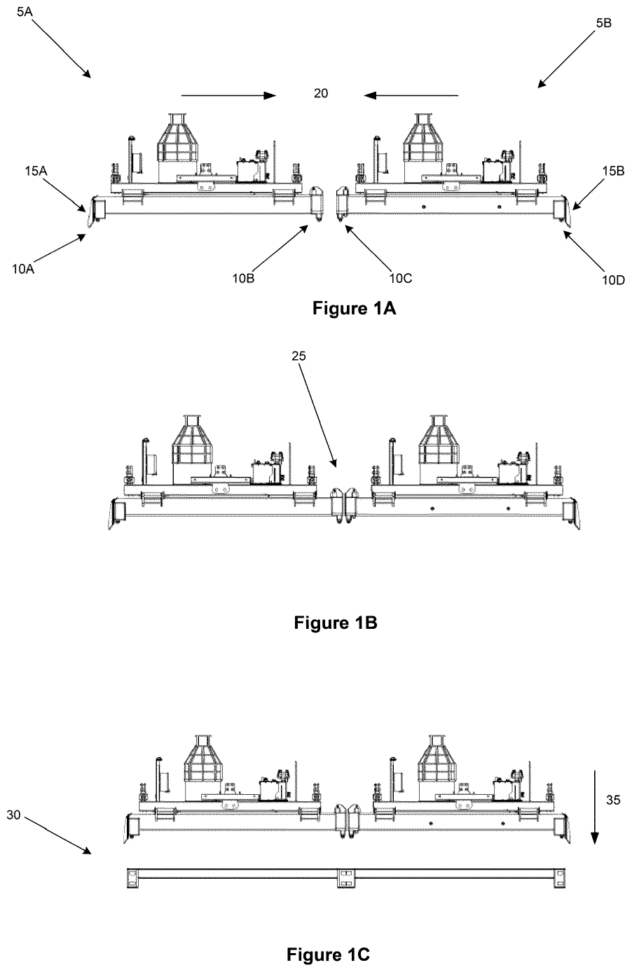

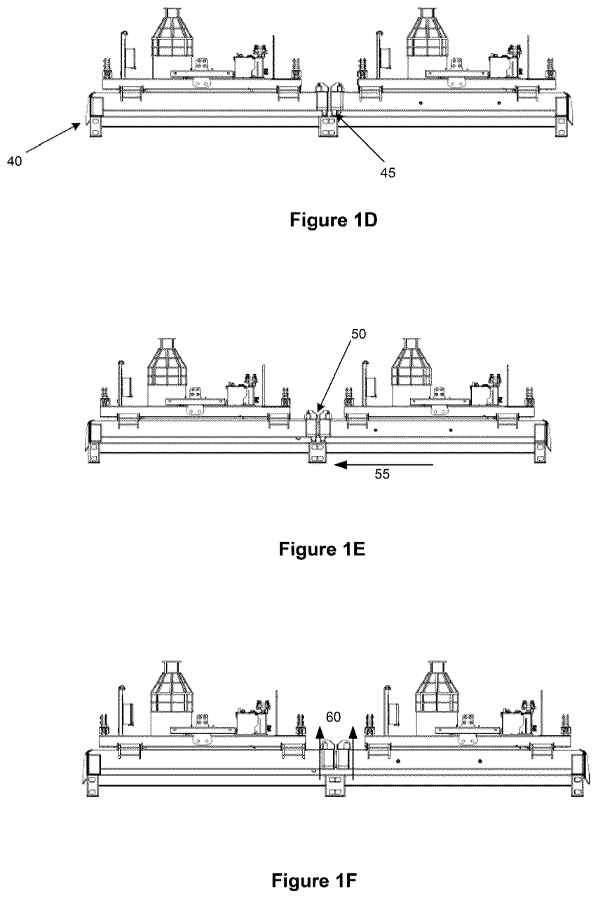

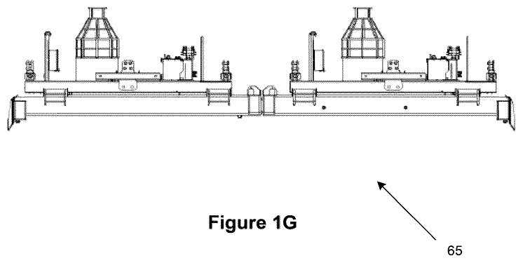

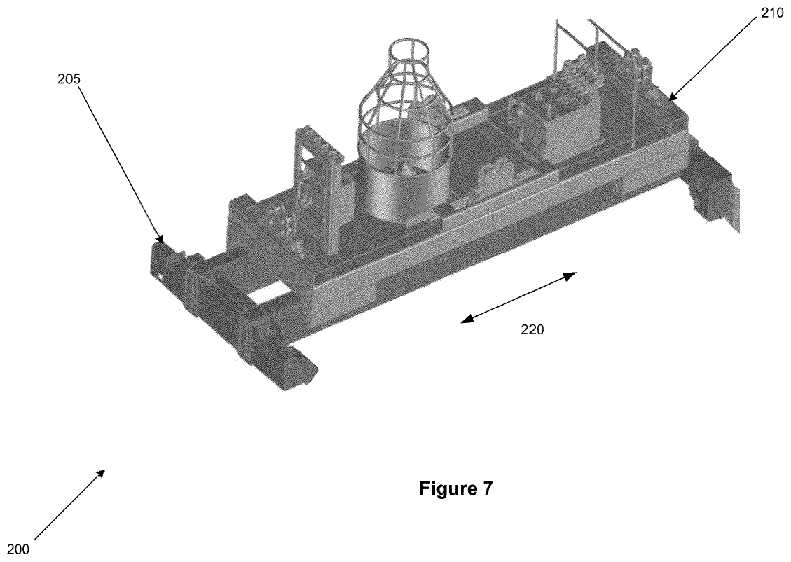

FIGS. 1A to 1G show two couplable spreaders 5A, 5B according to the present invention. Each spreader is arranged to handle individual containers separately, and in particular for 20 ft containers. Each spreader 5A, 5B includes spreader guides 15A, 15B, which may be fixed guide or gather guide (such as flippers) as well as external twistlocks 10A, 10D positioned at an external edge of the spreader and internal twistlocks 10B, 10C. The two spreaders 5A, 5B are brought together 20 such as by longitudinal adjustment 220 of spreader as shown in FIG. 7 to be proximate to each other at a coupling point 25.

The spreaders are lowered 35 onto a frame 30 with the spreader guides 15A, 15B engaging with the ends of the frame 30 so as to confirm to the operator that the spreaders are in place to commence the coupling process. In this embodiment, the coupling process begins by having telescopic projections project 55 from a first spreader 5B into apertures of the second spreader 5A creating the couple 50.

The internal twistlocks 10B, 10C are then retracted 60 into the respective spreaders so that, for later use, the internal twistlocks do not interfere with the engagement of a 40 foot container. On completion of the coupling process the unitary spreader 65 is then available for use to handle 40 ft containers.

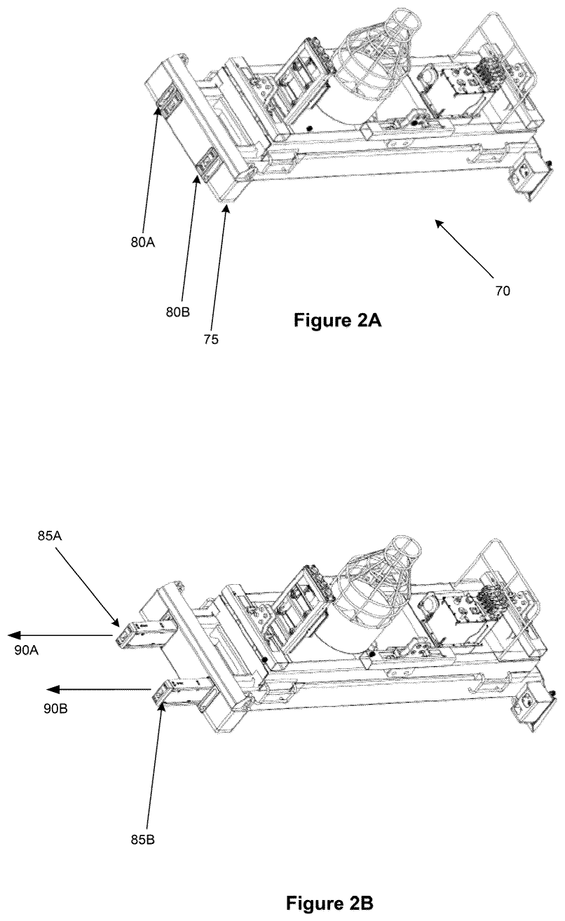

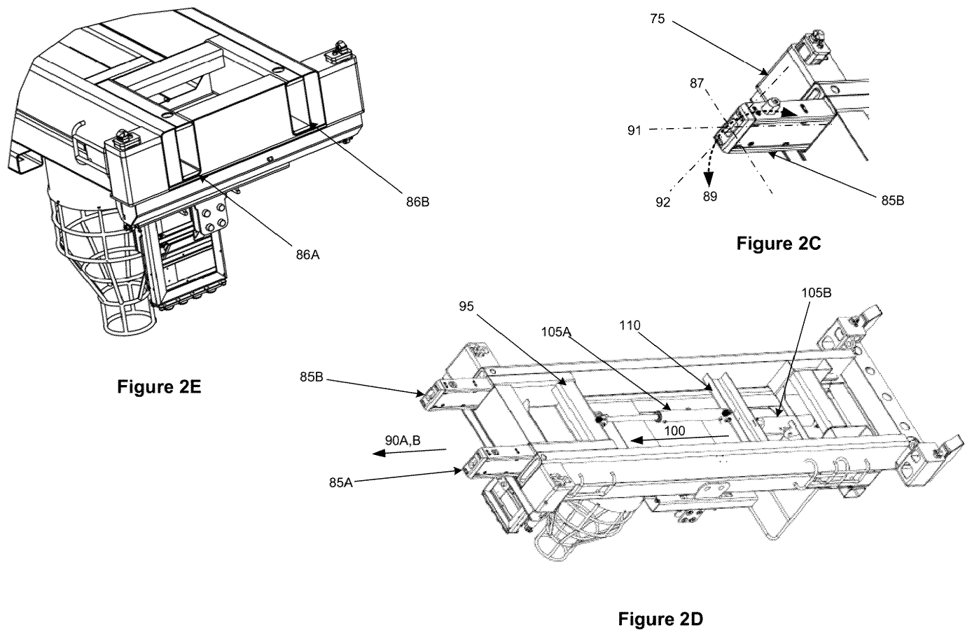

FIGS. 2A to 2E show one embodiment of a load transfer coupling system. Here the projections 85A, 85B project 90A, 90B from a coupling end of the 1st spreader. The projections 85A, 85B in this embodiment are legs of a U-shaped frame 95 which is actuated 100 by an actuator, or ram 105A, mounted to a reaction beam 110. Thus, when in position, the projections extend from the spreader 75 and engage with corresponding apertures 86A, B at a coupling end of a 2nd spreader. In this embodiment, the projections 85A,B are beams having the major cross sectional axis 92 vertically oriented, and so have a higher flexural stiffness 89 about an axis 87 perpendicular to a longitudinal axis 91 of the first spreader. The projections are able to transfer moment through the coupling of the spreaders, forming a stiff or rigid connection, such that the coupled spreaders act as a single unitary structure. To this end, the U-shaped frame 95 may reside in a sliding connection within the spreader to ensure a complete transfer of force from one spreader through the projections and into the next spreader to avoid, for instance, any differential deformation about the couple.

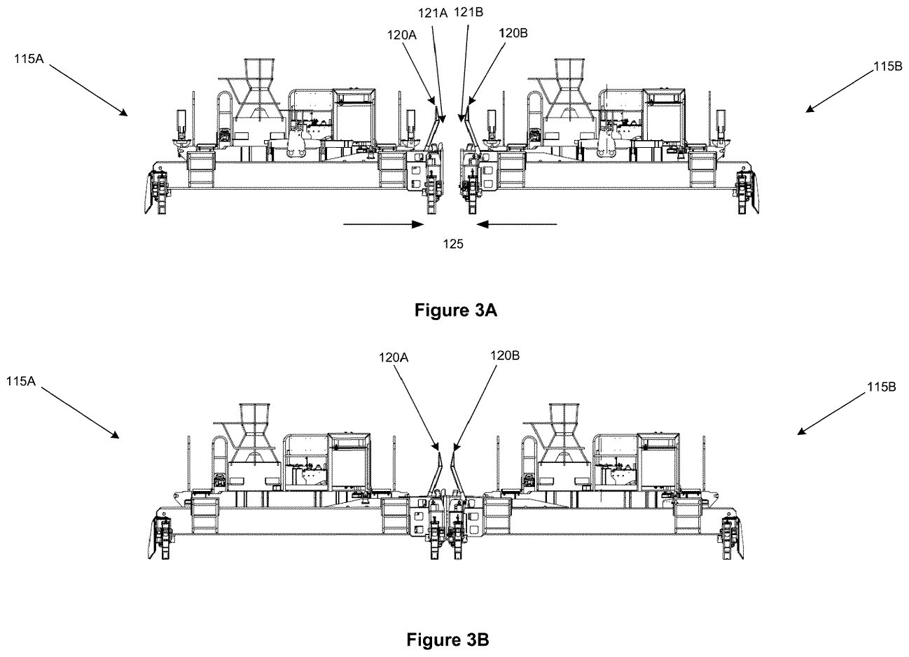

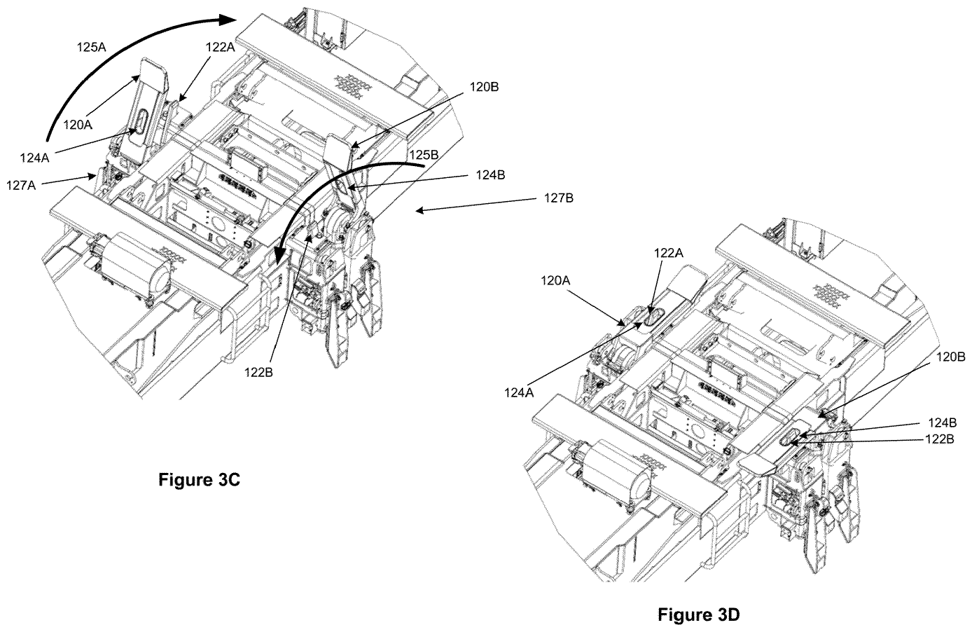

FIGS. 3A to 3D show a guide clamp assembly, located at a coupling end of the spreader, for aligning the spreaders for subsequent coupling. This system is particularly useful where a supporting frame or container is unavailable. By clamping adjacent spreaders prior to coupling, the coupling process may be effected in mid-air.

FIGS. 3A to 3D show two spreaders 115A, 115B being brought together 125 such as by longitudinal adjustment 220 of spreader as shown in FIG. 7 so as to bring into proximity guide clamps 120A, 120B. The guide clamps are arranged at the extreme ends which, when coupled together, form the inner ends 121A, B of the spreaders 115A, 115B. As shown in FIG. 3C), the two clamps 120A, B each positioned on one corner 127A, B of the respective spreaders. As each clamp 120A, 120B rotates 125A, 125B when the spreaders are approximate to each other, the clamps 120A, 120B engage with the opposed spreader so as to lock the spreaders together. Each guide clamp includes a recess 124A, B for receiving a lug 122A, B when the guide clamp is in place assisting with locking the guide clamps in place.

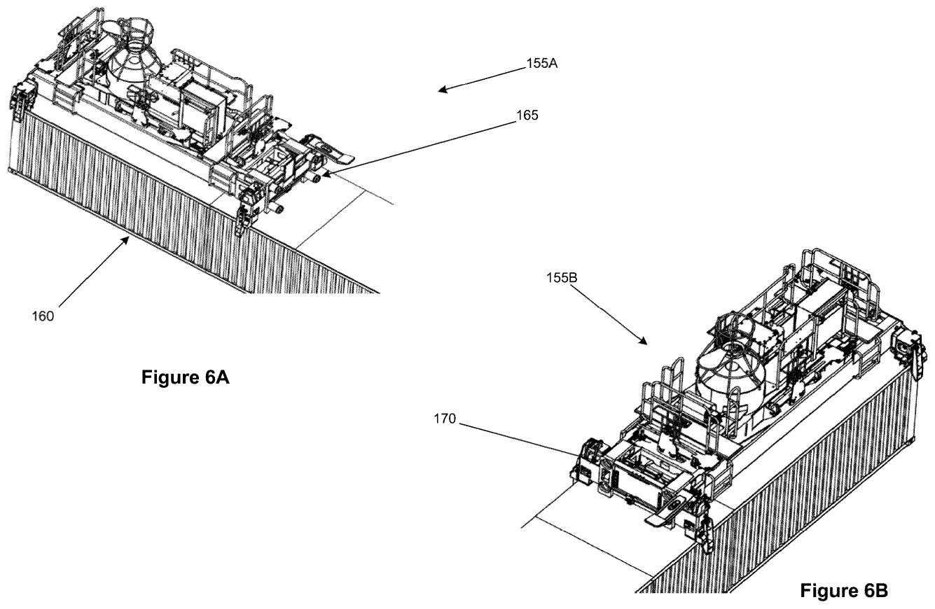

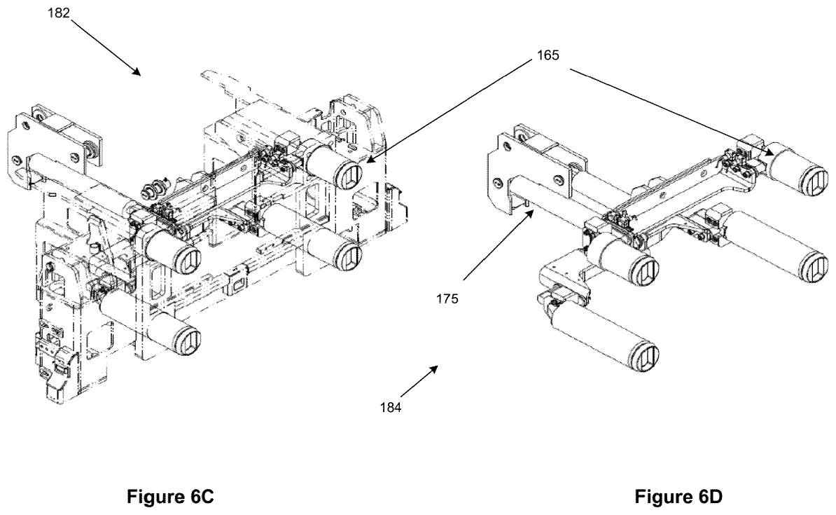

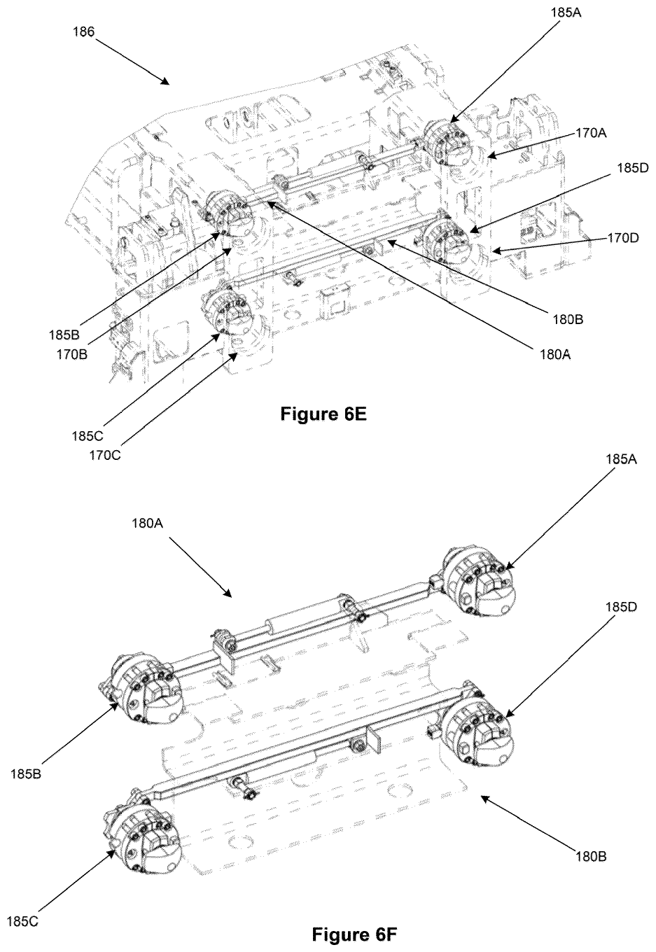

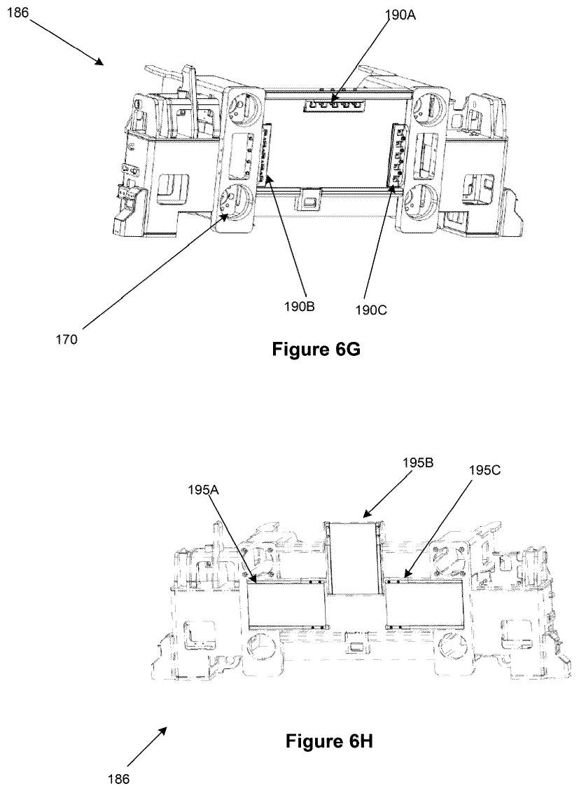

The guide clamps 120A, 120B are not intended to be load transfer members but instead act as a positioning tool when the spreaders are first brought 125 into proximity with each other. Once the guide clamps are in place, the moment transfer coupling system such as that shown in FIGS. 2A to 2E or FIGS. 6A to 6H can then secure the couple. Thus, the guide clamps may be applicable with either moment/load transfer coupling systems.

Each spreader includes a lifting frame for engaging the container, with twistlocks located at each corner. As discussed, the internal twistlocks located at a coupling end of the lifting frame may interfere when the subsequent unitary spreader engages a 40 foot container.

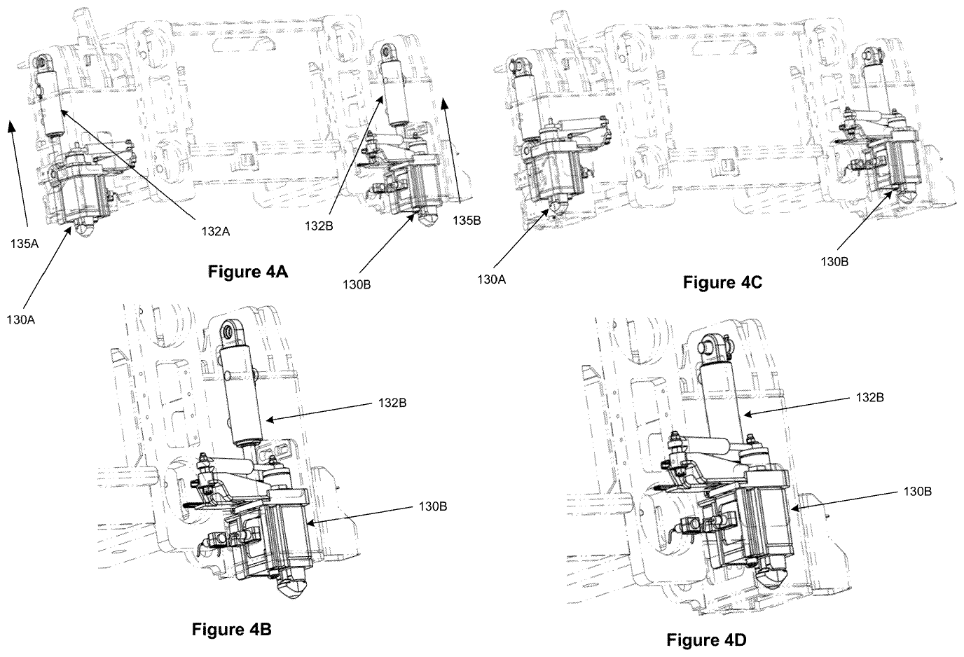

To this end, FIGS. 4A to 4D show a twistlock retraction system whereby internal twistlocks 130A, B are mounted so as to have a linear movement arrangement and so linearly retract 135A, B using respective actuators, or hydraulic rams 132A, 132B. Thus, as part of the coupling process the twistlocks 130A, 130B may be retracted so as to permit use with handling a 40 foot container.

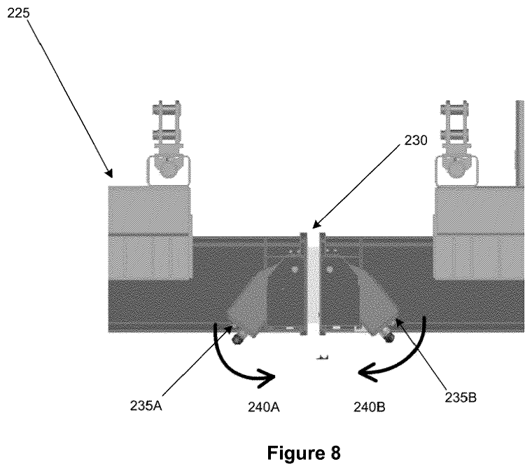

FIG. 8 shows an alternative twistlock retraction system whereby twistlocks 235A, B located near the coupling 230 of the spreaders 225 are rotated out of position 240A, B or during decoupling rotated back into place. Thus, FIG. 8 provides an example of a twistlock retraction system whereby the twistlocks are rotationally retracted about a pivot to which the twistlocks are mounted, rather than linearly retracted, by an actuator.

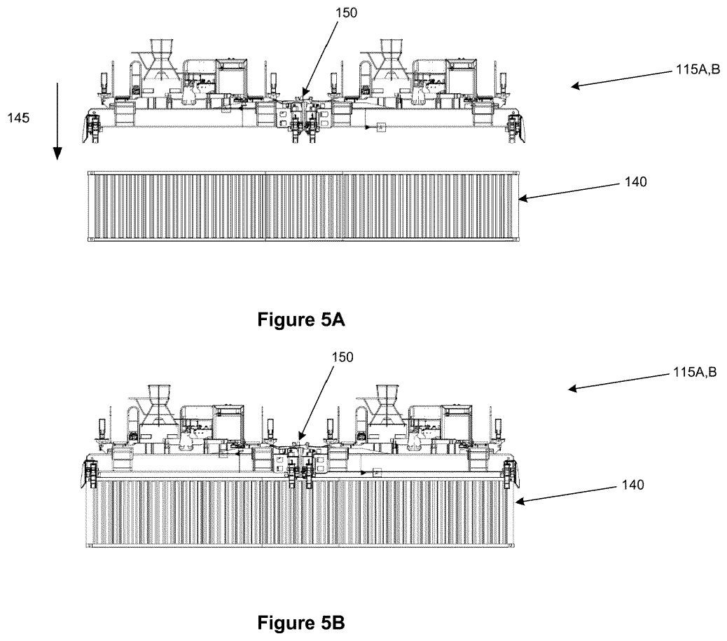

FIGS. 5A and 5B show an alternative process for coupling the 2 spreaders 115A, B. Here instead of a frame as shown in FIGS. 1A to 1G, a container 140 provides the base where the two spreaders 115A, B can be placed 145 in order for the coupling 150 to be effected.

In a further process, the spreaders may be coupled while in mid-air. Several alignment features may be incorporated into the spreaders, such that a supporting frame of FIGS. 1A-1G, or a supporting container of FIGS. 5A and 5B are not necessary. Such alignment features include the clamps of FIGS. 3A to 3D or the alignment systems of FIGS. 6G and 6H. Further, the fine adjustment system of FIG. 8, provides for a system to make the final approach after bringing two spreaders into a proximate position for coupling.

FIGS. 6A to 6F show an alternative load transfer coupling system for coupling the couplable spreaders 155A, B to secure said spreaders as a single unitary spreader.

On a first spreader is located a projection block 182 having a projection assembly 184 for extending a plurality of projections, in this case rods 165, out from the block 182. The rods are extended or retracted using actuators, such as hydraulic rams 175. Each rod includes a slot in a leading face of the rod for engaging with a twistlock. On the adjacent spreader is located an engagement block 186 having apertures 170 A-D for receiving the leading face of the rods. Once the two spreaders are proximate and aligned, the rods are projected into the apertures 170 A-D.

Located within the engagement block 186 are twistlock assemblies 180A, B connecting a pair of twistlocks 185A-D within the apertures 170A-D. Thus, as the leading face of the rods 165 enter the apertures 170A-D, the slots within the face of the rods 165 selectively engaged with the twistlocks 185 A-D to securely couple the projection block 182 and engagement block 186 in a selectively fixed engagement. The flexural capacity of the rods 165 are such that once engaged with the apertures and corresponding twistlocks 185, the coupling system forms a load transfer couple to transfer load across the coupling, to ensure the spreaders act as a single unitary spreader.

FIGS. 6G and 6H show an alignment system with height and level optical detectors 190A to 190C, such that the optical detectors operate with reflectors 195A to 195C placed on the opposed block 186. Thus, to ensure that the spreaders are brought proximate to each other and aligned, the alignment system comprising the optical detectors and reflectors provide an automated feedback to the operator to ensure the load transfer assembly is ready to commence the coupling process.

It will be appreciated that the guide clamps of FIGS. 3A to 3D are usable with either the load transfer coupling systems of FIGS. 2A to 2E and FIGS. 6A to 6H, or as a separate system all together.

FIG. 7 shows a horizontal alignment system whereby the headframe 210 and the lifting frame 205, that form the spreader 200, move horizontally 220 relative to each other. Thus, to achieve alignment with the overhead trolley, sliding the components 205, 210 relative to each other allow for the 2 spreaders to be brought proximate to each other end to end such as in movement 20 shown in FIG. 1A and movement 125 shown in FIG. 3A. This system therefore provides a fine adjustment for the final positioning prior to coupling adjacent spreaders. In this embodiment, the relative sliding 220 may be achieved by an actuator, such as a hydraulic ram, capable of applying an appropriate load plus a feedback loop of load sensors that may allow the operator to effect the horizontal adjustment to bring the two spreader together.

1. A spreader system comprising:
a pair of couplable spreaders;
a first of the pair of spreaders having at least one projection, said projection arranged to selectively extend from a coupling end of the first spreader into an aperture defined in a coupling end of the second spreader, when said spreaders are proximate to each other;
wherein, on receiving the at least one projection into said corresponding aperture, a load transfer couple is formed such that the two couplable spreaders are arranged to act as a single unitary spreader.

2. The system according to claim 1, wherein there are two projections, each projection having a higher flexural stiffness about an axis perpendicular to a longitudinal axis of the first spreader.

3. The system according to claim 1, wherein there are a plurality of projections, each projection defining a slot in a leading face of the projection, and;
each corresponding aperture in the second spreader including a twistlock;
wherein the twistlock is arranged to engage with the casting to form the load transfer couple.

4. The system according to claim 3, wherein the projections are rods.

5. The system according to claim 1, wherein each spreader includes a head frame mounted on a lifting frame, said lifting frame arranged to engage a container;
said lifting frame having a twistlock at each corner;
wherein the twistlocks are located at a coupling end of the lifting frame are selectively retractable.

6. The system according to claim 5, further including a linear movement arrangement to which said retractable twistlocks are mounted, and an actuator arranged to linearly retracting said retractable twistlocks.

7. The system according to claim 5, further including a pivot to which said retractable twistlocks are mounted, and an actuator for rotationally retracting said retractable twistlocks about said pivot.

8. The system according to claim 1, further including guide clamps at a coupling end of each spreader;
said guide clamps rotationally mounted to said spreader, and arranged to rotate about an axis perpendicular to a longitudinal axis of the spreader;
wherein the guide clamps are arranged to rotate and engage with the other spreader, when coupling ends of the spreaders are proximate to each other.

9. The system according to claim 1, wherein the head frame and the lifting frame are in sliding engagement, and arranged to selectively slide relative to each other.

10. A method of coupling a pair of couplable spreaders, the method comprising the steps of:
bringing coupling ends of said spreaders proximate to each other;
selectively extending at least one projection from a first of said spreaders inserting the at least projection into a corresponding aperture defined by a second of said spreaders;
and consequently, forming a load transfer couple such that the two couplable spreaders are arranged to act as a single unitary spreader.

11. The method of claim 10, further including the step, after the inserting step, of:
engaging a slot defined in a leading face of said projection with a twistlock in the corresponding aperture.

12. The method of claim 10, further including the step of:
selectively retracting twistlocks at each corner of a lifting frame of said spreaders.

13. The method of claim 10, wherein the retracting step includes:
linearly retracting the twistlocks to which said retractable twistlocks are mounted.

14. The method of claim 10, wherein the retracting step includes:
rotationally retracting the twistlocks about a pivot to which said retractable twistlocks are mounted.

15. The method of claim 10, further including the steps of:
rotating guide clamps at a coupling end of each spreader, about an axis perpendicular to a longitudinal axis of the spreader, and;
engaging the guide clamps with the other spreader, when coupling ends of the spreaders are proximate to each other.
